(19) United States
(12) Patent Application Publication
(10) Pub. No.: US 2026/0246663 A1
(43) Pub. Date: Aug. 20, 2026

(54) CAN COMMUNICATION APPARATUS AND METHOD IN VIRTUAL INTERFACE ENVIRONMENT

(71) Applicant: HYUNDAI AUTOEVER CORP., Seoul (KR)

(72) Inventors: Kang Young LEE, Seoul (KR); Seok Jin JANG, Seoul (KR); Eun Hyung CHO, Seoul (KR); Seung Ho HAN, Seoul (KR); Jae Eun KIM, Seoul (KR)

(21) Appl. No.: 19/544,016

(22) Filed: Feb. 19, 2026

(30) Foreign Application Priority Data
Feb. 20, 2025 (KR) 10-2025-0022536

(51) Int. Cl. H04L 12/40; G06F 9/455

(52) U.S. Cl. CPC H04L 12/40013; G06F 9/455; H04L 2012/40215; H04L 2012/40273

(57) ABSTRACT

Controller Area Network (CAN) communication apparatus and methods in a virtual interface environment are described. According to one embodiment, the CAN communication method includes driving, by a processor, a virtual interface environment including a virtual CAN communication function, converting, by the processor, a CAN message into a string according to a communication protocol using a streaming method, and performing, by the processor, a virtual CAN communication by transmitting the converted string.

### CROSS-REFERENCE TO RELATED APPLICATION

This application claims priority from and the benefit of Korean Patent Application No. 10-2025-0022536, filed on Feb. 20, 2025, which is hereby incorporated by reference for all purposes as if set forth herein.

### BACKGROUND

### Field

Exemplary embodiments of the present disclosure relate to a controller area network (CAN) communication apparatus and method in a virtual interface environment, and more particularly, to a CAN communication apparatus and method in a virtual interface environment based on a functional mockup interface (FMI).

### Discussion of the Background

Classic automotive open system architecture (AUTOSAR) is standard software architecture for a vehicle electronic control system, and is basically used to develop electronic control unit (ECU) software for a vehicle.

In a process of developing and testing software for the ECU to which the Classic AUTOSAR standard has been applied, conventionally, tests are basically performed based on an actual controller. In such a case, there are problems in that a lot of time is taken to construct a test environment because a hardware-in-the-loop simulation (HISL) system or an actual board needs to be used and various tests are difficult due to the limitations of the number of boards.

A functional mockup interface (FMI) is a standard for exchanging models for a physical system and performing co-simulation. When a model is used in a virtual interface environment based on the FMI, the FMI has a problem in that there is difficulty in simulating an actual CAN communication environment for a vehicle because the FMI is implemented differently from an actual CAN communication method for a vehicle.

### SUMMARY

Various embodiments are directed to providing a CAN communication apparatus and method in a virtual interface environment, which can implement the virtualization of an ECU and simulate an actual CAN communication environment for a vehicle

In an embodiment, a controller area network (CAN) communication apparatus in a virtual interface environment includes a processor and memory configured to store commands executed by the processor. When executed by the processor, the commands enable the processor to drive a virtual interface environment including a virtual CAN communication function, convert a CAN message into a string according to a communication protocol using a streaming method when the virtual CAN communication function operates, and perform virtual CAN communication by transmitting the converted string.

In an embodiment of the present disclosure, the virtual interface environment is a virtual interface environment based on a functional mockup interface (FMI).

In an embodiment of the present disclosure, the virtual interface environment is constituted with a virtual controller, and includes virtual operation software (OS), a virtual micro controller abstraction layer (MCAL), and a virtual complex driver (CCD).

In an embodiment of the present disclosure, the virtual controller virtualizes a basic software (BSW) layer based on classic automotive open system architecture (AUTOSAR).

In an embodiment of the present disclosure, the communication protocol includes a header, a message ID, a data length, and data.

In an embodiment of the present disclosure, the commands enable the processor to convert a plurality of CAN messages to be transmitted at each time point into strings, respectively, and to generate a virtual CAN message as a single string by connecting the converted strings.

In an embodiment of the present disclosure, the virtual CAN communication function includes only one string interface.

In an embodiment, a controller area network (CAN) communication method in a virtual interface environment includes driving, by a processor, a virtual interface environment including a virtual CAN communication function, converting, by the processor, a CAN message into a string according to a communication protocol using a streaming method, and performing, by the processor, virtual CAN communication by transmitting the converted string.

In an embodiment of the present disclosure, the virtual interface environment is constituted with a virtual controller.

According to an embodiment of the present disclosure, in the converting of the CAN message into the string, the processor converts a plurality of CAN messages to be transmitted at each time point into strings, respectively, and generates a virtual CAN message as a single string by connecting the converted strings.

The CAN communication apparatus and method in the virtual interface environment according to embodiments of the present disclosure have an effect in that an operating method for an actual CAN bus can be simulated because virtual CAN communication is performed by converting a CAN message into a string according to a communication protocol using a streaming method.

The CAN communication apparatus and method in the virtual interface environment according to embodiments of the present disclosure have an effect in that a driving time can be reduced and performance can be improved by reducing the use of I/Os by the virtual controller because a communication function can be performed through a single string-based interface.

### BRIEF DESCRIPTION OF THE DRAWINGS

FIG. 1 is a block diagram illustrating a configuration of a CAN communication apparatus in a virtual interface environment according to an embodiment of the present disclosure.

FIG. 2 is an exemplary diagram for describing a configuration of the ECU of the CAN communication apparatus in the virtual interface environment according to an embodiment of the present disclosure.

FIGS. 3 to 5 are exemplary diagrams for describing the virtualization of the ECU of the CAN communication apparatus in the virtual interface environment according to an embodiment of the present disclosure.

FIG. 6 is an exemplary diagram for describing a CAN message in the CAN communication apparatus in the virtual interface environment according to an embodiment of the present disclosure.

FIG. 7 is an exemplary diagram for describing communication using a signaling method in a virtual interface environment based on an FMI.

FIG. 8 is an exemplary diagram for describing a communication protocol using a string method in the CAN communication apparatus in the virtual interface environment according to an embodiment of the present disclosure.

FIG. 9 is an exemplary diagram for describing a CAN message using the streaming method in a virtual interface environment according to an embodiment of the present disclosure.

FIG. 10 is an exemplary diagram for describing communication using the streaming method in a virtual interface environment according to an embodiment of the present disclosure.

FIG. 11 is a flowchart for describing a CAN communication method in a virtual interface environment according to an embodiment of the present disclosure.

### DETAILED DESCRIPTION OF THE ILLUSTRATED EMBODIMENTS

Hereinafter, a controller area network (CAN) communication apparatus and method in a virtual interface environment according to embodiments of the present disclosure are described with reference to the accompanying drawings. In this process, the thicknesses of lines or the sizes of components illustrated in the drawings may have been exaggerated for the clarity of a description and for convenience’ sake. Terms to be described below have been defined by taking into consideration their functions in the present disclosure, and may be changed depending on a user or operator's intention or practice. Accordingly, such terms should be defined based on the overall contents of this specification.

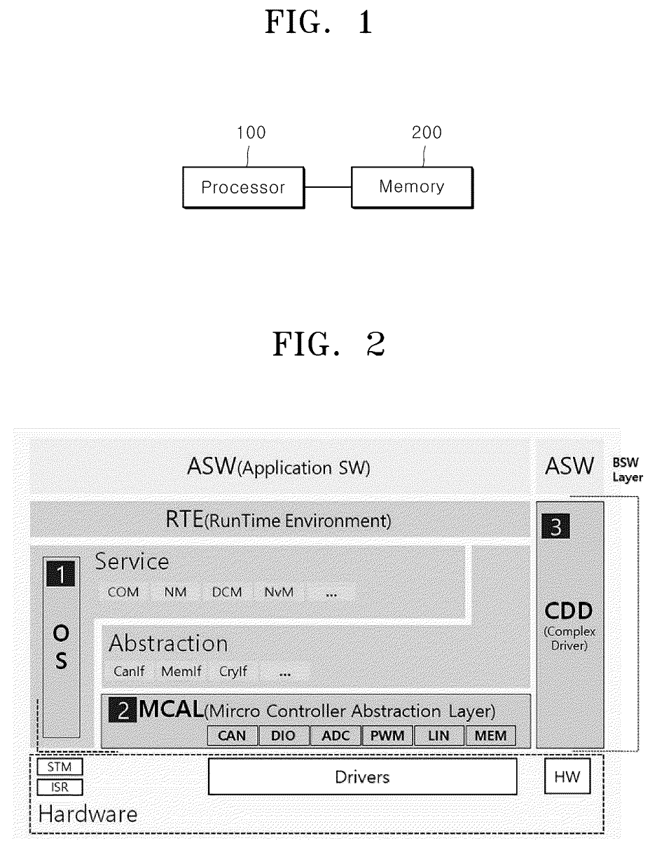

FIG. 1 is a block diagram illustrating a configuration of a controller area network (CAN) communication apparatus in a virtual interface environment according to an embodiment of the present disclosure.

As illustrated in FIG. 1, the CAN communication apparatus in the virtual interface environment according to an embodiment of the present disclosure includes a processor 100 and memory 200. The CAN communication apparatus in the virtual interface environment according to an embodiment of the present disclosure may be implemented with a computing device.

The memory 200 may include at least one storage medium, among a flash memory type, a hard disk type, a multimedia card micro type, card type memory, random access memory (RAM), static random access memory (SRAM), read-only memory (ROM), programmable read-only memory (PROM), erasable programmable read-only memory (EPROM), or electrically erasable programmable read-only memory (EEPROM).

The processor 100 may be connected to the memory 200, and may execute a command stored in the memory 200. The processor 100 may control at least another component (e.g., hardware or software component) connected to the processor 100 and perform various data processing or operations by executing the command stored in the memory 200.

Furthermore, the processor 100 may be constituted with components for performing functions at a hardware, software, or a logic level. In such a case, dedicated hardware for performing each function may be used. To this end, the processor 300 may be implemented with at least one, among an application-specific integrated circuit (ASIC), a digital signal processor (DSP), programmable logic devices (PLD), field programmable gate arrays (FPGAs), a central processing unit (CPU), microcontrollers and/or microprocessors, or may include at least one of them.

The processor 100 may be implemented with a central processing unit (CPU) or a system on chip (SoC), and may control a plurality of hardware or software components connected to the processor 100 and perform various data processing and operations by driving an operating system or an application. The processor 100 may be configured to execute at least one instruction stored in the memory 200, and may store the results of the execution data in the memory 200.

FIG. 2 is an exemplary diagram for describing a configuration of the ECU of the CAN communication apparatus in the virtual interface environment according to an embodiment of the present disclosure.

As illustrated in FIG. 2, an ECU based on Classic AUTOSAR may be divided into an application software (ASW) layer, a basic software (BSW) layer, and a hardware layer. In this case, for tests in a virtual environment for the ECU, the virtualization of the ECU may be implemented. Specifically, in an embodiment of the present disclosure, a virtual controller may be implemented by virtualizing a portion that belongs to the BSW layer and that is connected to the hardware layer, thereby enabling the development and tests of software in a hardware-independent environment and improving efficiency of development.

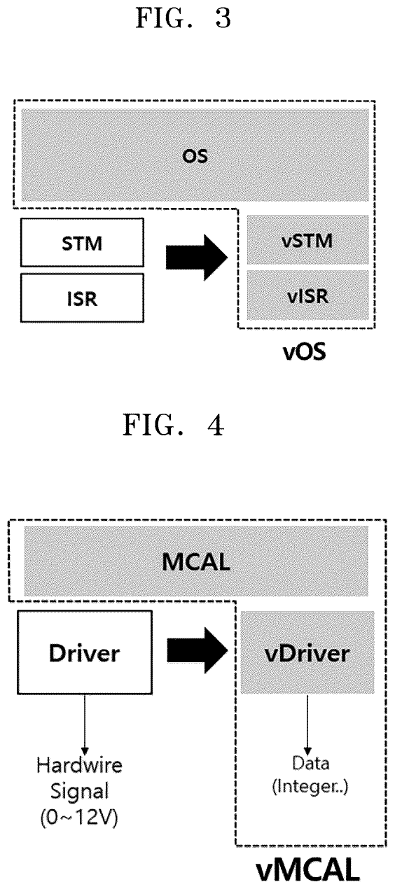

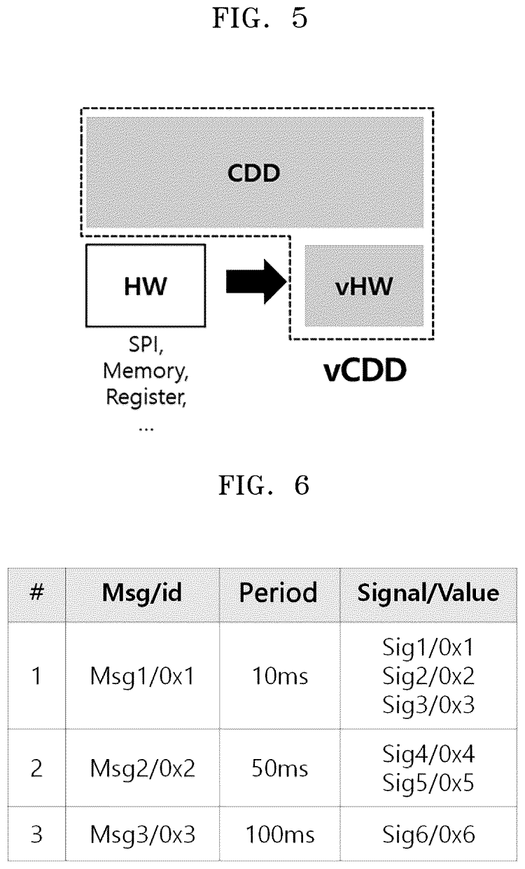

FIGS. 3 to 5 are exemplary diagrams for describing the virtualization of the ECU of the CAN communication apparatus in the virtual interface environment according to an embodiment of the present disclosure.

In an embodiment of the present disclosure, in a portion that belongs to the BSW layer and that is connected to the hardware layer, a virtual interface environment for the ECU may be provided by virtualizing operation software (OS), a micro controller abstraction layer (MCAL), and a complex driver (CCD).

First, in the case of the virtualization of the OS, the virtualization of the OS may be implemented by substituting (vSTM) a portion that belongs to STM hardware and that receives and alarms ticks with the reception of CPU ticks and substituting (vISR) all of interrupt processing (ISR)-related interfaces in a polling manner by registering a 5 ms task with a configuration.

In the case of the virtualization of the MCAL, the virtual driver (vDriver) may be implemented in a way to convert a hardware signal (e.g., 0 to 12 V) into a data (e.g., integer) form.

For example, in the case of the CAN, a code may be generated by reading information, such as “CanControllerId” or “CANTxObject”, from the existing CAN MCAL configuration information. In the case of DIO, a code may be generated by reading information “ch number” from the existing DIO MCAL configuration information. In the case of ADC, a code may be generated by reading information “ch number” from the existing ADC MCAL configuration information. In the case of PWM, a code may be generated by reading information “channel ID” or “period” from the existing PWM MCAL configuration information. In the case of MEM, a code may be generated by reading information “total size” or “block reference” from the existing Fls, Fee MCAL configuration information. In this case, the MEM may be implemented in the form of two pieces of virtual memory, such as “FLASH. bin” and “EEPROM. bin”.

The CCD may be implemented in a form that constructs the virtual driver of hardware, such as an SPI, memory, and a register.

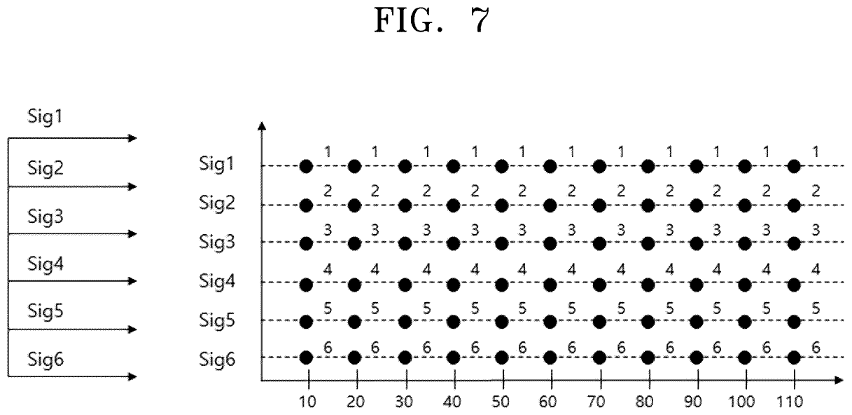

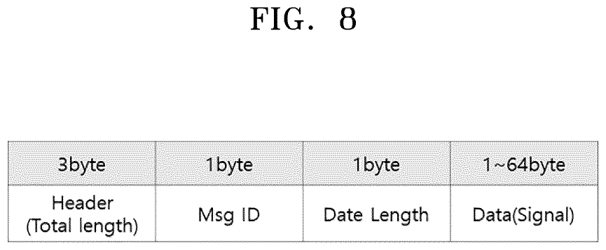

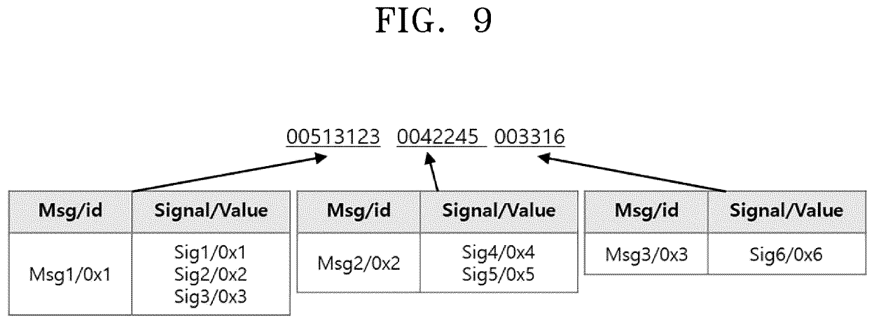

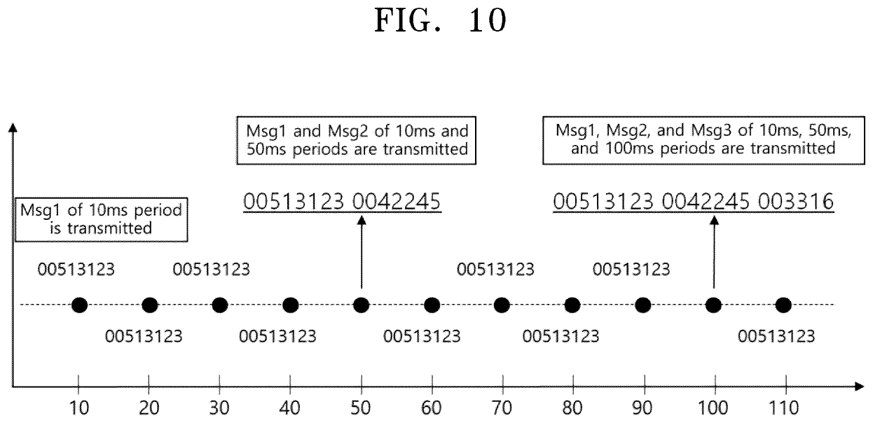

FIG. 6 is an exemplary diagram for describing a CAN message in the CAN communication apparatus in the virtual interface environment according to an embodiment of the present disclosure. FIG. 7 is an exemplary diagram for describing communication using a signaling method in a virtual interface environment based on an FMI. FIG. 8 is an exemplary diagram for describing a communication protocol using a string method in the CAN communication apparatus in the virtual interface environment according to an embodiment of the present disclosure. FIG. 9 is an exemplary diagram for describing a CAN message using the streaming method in a virtual interface environment according to an embodiment of the present disclosure. FIG. 10 is an exemplary diagram for describing communication using the streaming method in a virtual interface environment according to an embodiment of the present disclosure.

As illustrated in FIG. 6, a CAN communication method according to an embodiment of the present disclosure is described as follows by taking a case in which a CAN message includes a message 1 (Msg1/0x1) of a 10 ms period, a message 2 (Msg 2/0x2) of a 50 ms period, and a message 3 (Msg3/0x3) of a 100 ms period, the message 1 has three signal values, the message 2 has two signal values, and the message 3 has one signal value as an example.

FIG. 7 illustrates communication using an integer method. In the integer method, an integer interface is constituted with signals that construct a message not the message itself.

In such a case, there may be a disadvantage in that the number of I/Os for a virtual controller, corresponding to the number of signals, may be required because interfaces corresponding to a total number of signals are required. Accordingly, in such a method, when the virtual controller is implemented, a lot of time is taken for an I/O connection and performance may be degraded.

Furthermore, the integer method cannot implement a periodic transmission operation of a CAN message because the integer method is configured to transmit all of data of signal interfaces every step time (i.e., a data transmission period, e.g., 10 ms) of the FMI. That is, in the case of the message illustrated in FIG. 6, the signal value of the message 2 needs to be transmitted every 50 ms. However, if the integer method is used, overall I/O performance of the virtual controller may be degraded because data is transmitted every step time.

Accordingly, in the CAN communication apparatus in the virtual interface environment according to an embodiment of the present disclosure, a CAN message is transmitted according to a streaming method by using a communication protocol using a string method. Accordingly, a CAN communication operation of the virtual controller can be implemented in a form similar to an actual CAN communication environment for a vehicle.

As illustrated in FIG. 8, the communication protocol using the streaming method may include a header (total length), a message ID (Msg ID), a data length, and data (signal). For example, the header may have 3 bytes, the message ID may have 1 byte, the data length may have 1 byte, and the data may have 1 to 64 bytes.

When the CAN message of the virtual controller is transmitted, the processor 100 may simulate a CAN operation by converting all of messages into a single string by using such a protocol as illustrated in FIG. 9. In such a case, the disadvantage of the integer method can be solved because only one string interface (vCANBUS) is required.

For example, the messages 1 to 3 illustrated in FIG. 6 may be converted into strings 00513123, 0042245, and 003316, respectively, as illustrated in FIG. 9. A CAN message may be transmitted by converting the messages 1 to 3 into a single string. In this case, each string may include 005 (header)1 (message ID)3 (data length)123 (data), 004 (header)2 (message ID)2 (data length)45 (data), and 003 (header)3 (message ID)1 (data length)6 (data).

If the streaming method is used, as illustrated in FIG. 10, a CAN message transmitted to an actual CAN BUS every step time of the FMI may be transmitted in a string form. When two or more CAN messages are transmitted, two strings may be configured subsequently to a single string and transmitted.

That is, as illustrated in FIG. 10, at a 10 ms time point, the message 1 of the 10 ms period is transmitted. At a 50 ms time point, the message 1 of the 10 ms period and the message 2 of the 50 ms period are transmitted at once. At a 100 ms time point, the message 1 of the 10 ms period, the message 2 of the 50 ms, and the message 3 of the 100 ms period are transmitted at once.

Such an operation can improve performance compared to the integer method because the operation is the same as a period transmission operation of an actual CAN message for a vehicle and all of CAN data is not transmitted every time.

In an FMI-based co-simulation environment, in general, interface variables are exchanged every step time. Accordingly, it is difficult to simulate message transmission on a per-period basis (e.g., 10 ms/50 ms/100 ms), as in an operation of an actual CAN bus, as well as to emulate simultaneous transmission of multiple messages at a specific time point without any change. Furthermore, if a signal unit interface is used, the number of I/O interfaces is increased in proportion to the number of signals, and an unnecessary data exchange and a processing load are increased because all of signals are exchanged every step.

In an embodiment of the present disclosure, in order to solve such a limit, a virtual CAN bus operation is implemented in a way to include only messages that need to be actually transmitted in each step by applying length-based framing (header) and a message aggregation so that a plurality of CAN messages can be transmitted through a single string interface.

The processor 100 manages a transmission period and a next transmission time point (or a step count reference transmission condition) with respect to each CAN message, and selects messages that satisfy a transmission condition in each step. Each selected message is serialized in the string form. A plurality of selected frames is sequentially connected and generated as a single string. The generated single string is transmitted based on a single string variable (or through a single I/O channel) that is provided in an FMI environment, such that a period transmission operation in the CAN bus is simulated even in a step-based environment.

The reception side determines a frame boundary by sequentially parsing an input string according to a frame length including a header, and restores a message ID, a data length, and data from each frame. A restored CAN message is stored in the reception buffer/queue of a virtual CAN driver (or a virtual MCAL) so that a higher layer (BSW/ASW) can process the CAN message in the same manner as the reception of an actual CAN message. Accordingly, according to an embodiment of the present disclosure, data is not simply converted, but a transmission and reception processing structure for a CAN bus is implemented in a virtual interface environment.

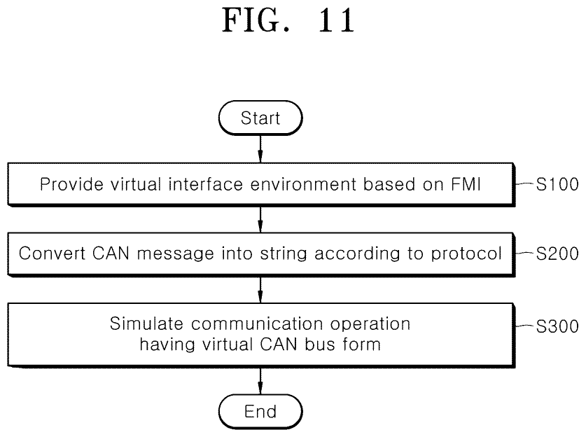

FIG. 11 is a flowchart for describing a CAN communication method in a virtual interface environment according to an embodiment of the present disclosure.

As illustrated in FIG. 11, the processor 100 first provides a virtual interface environment based on the FMI by driving the virtual interface environment based on the FMI (S100). In this case, the virtual interface environment based on the FMI includes a virtual controller obtained by virtualizing the ECU of a vehicle. The virtual controller may include the virtual OA, the virtual MCAL, and the virtual CCD.

Next, the processor 100 converts a CAN message into a string according to the communication protocol using the streaming method (S200). That is, the processor 100 may configure a virtual CAN message having a string form by converting the CAN message into the string according to the protocol illustrated in FIG. 8.

Thereafter, the processor 100 simulates a communication operation of a CAN bus by performing communication having a virtual CAN bus form by transmitting the converted string (S300). That is, the processor may simulate a CAN bus communication operation of an actual controller for a vehicle in a way to transmit the string converted from the CAN message.

Although embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A controller area network (CAN) communication apparatus in a virtual interface environment, the CAN communication apparatus comprising:
a processor; and
a memory configured to store commands executed by the processor,
wherein, when being executed by the processor, the commands enable the processor to:
drive a virtual interface environment including a virtual CAN communication function,
convert a CAN message into a string according to a communication protocol using a streaming method when the virtual CAN communication function operates, and
perform a virtual CAN communication by transmitting the converted string.

2. The CAN communication apparatus of claim 1, wherein the virtual interface environment is based on a functional mockup interface (FMI).

3. The CAN communication apparatus of claim 1, wherein the virtual interface environment comprises a virtual controller and a virtual operation software (OS), a virtual micro controller abstraction layer (MCAL), and a virtual complex driver (CCD).

4. The CAN communication apparatus of claim 3, wherein the virtual controller virtualizes a basic software (BSW) layer based on a classic automotive open system architecture (AUTOSAR).

5. The CAN communication apparatus of claim 1, wherein the communication protocol comprises a header, a message ID, a data length, and data.

6. The CAN communication apparatus of claim 1, wherein the commands enable the processor to convert a plurality of CAN messages to be transmitted at each time point into strings, respectively, and to generate a virtual CAN message as a single string by connecting the converted strings.

7. The CAN communication apparatus of claim 6, wherein the virtual CAN communication function comprises only one string interface.

8. A controller area network (CAN) communication method in a virtual interface environment, the CAN communication method comprising:
driving, by a processor, the virtual interface environment comprising a virtual CAN communication function;
converting, by the processor, a CAN message into a string according to a communication protocol using a streaming method; and
performing, by the processor, a virtual CAN communication by transmitting the converted string.

9. The CAN communication method of claim 8, wherein the virtual interface environment comprises a virtual controller.

10. The CAN communication method of claim 8, wherein the communication protocol comprises a header, a message ID, a data length, and data.

11. The CAN communication method of claim 8, wherein in the converting of the CAN message into the string, the processor converts a plurality of CAN messages to be transmitted at each time point into strings, respectively, and generates a virtual CAN message as a single string by connecting the converted strings.

12. The CAN communication method of claim 8, wherein the virtual CAN communication function comprises only one string interface.
